(19) United States
(12) Patent Application Publication
(10) Pub. No.: US 2026/0139730 A1
(43) Pub. Date: May 21, 2026

(54) CLUTCH WITH REGENERATION CAPABILITY

(71) Applicant: Rivian IP Holdings, LLC, Irvine, CA (US)

(72) Inventors: Vinaey Kalyanaraman, Rancho Palos Verdes, CA (US); Mason Verbridge, Canton, MI (US); Gary Allen Pinkley, Northville, MI (US)

(21) Appl. No.: 19/392,694

(22) Filed: Nov. 18, 2025

Related U.S. Application Data
(60) Provisional application No. 63/722,748, filed on Nov. 20, 2024.

(51) Int. Cl. F16H 48/24; F16H 48/08

(52) U.S. Cl. CPC F16H 48/24; F16H 48/08

(57) ABSTRACT

Techniques are provided herein for implementing a clutch. In some embodiments, a clutch includes a drive plate configured to be coupled to a first shaft. The drive plate includes a first plurality of pawl elements and a first plurality of pockets. The clutch includes a transfer plate configured to be coupled to a second shaft, the transfer plate includes a second plurality of pockets and a second plurality of pawl elements. In certain embodiments, the first plurality of pockets are configured to receive the second plurality of pawl elements, and the second plurality pockets are configured to receive the first plurality of pawl elements. In some embodiments, the disclosed clutch is implemented with a differential of a vehicle. In other embodiment, the disclosed clutch is implemented in a half shaft assembly of a vehicle.

### CROSS-REFERENCE TO RELATED APPLICATION

This application claims the benefit of U.S. Provisional Ser. No. 63/722,748, filed Nov. 20, 2024, the disclosure of which is hereby incorporated by reference herein in its entirety.

### INTRODUCTION

The present disclosure relates to clutches, and in particular to one-way clutches that have regeneration capabilities.

### SUMMARY

Vehicles, particularly electric vehicles, engage and disengage certain drivetrain components from other drivetrain components. For example, disconnecting drivetrain components decreases the rotational load of the overall drivetrain. Doing so helps save electrical power stored in the electric vehicle's battery. However, disengaging and re-engaging drivetrain components that are rotating at different rotational velocities can cause excessive noise, vibration, and harshness to the vehicle and diminish the user's experience of the vehicle. Additionally, excessive noise, vibration, and harshness can increase the amount of wear certain components experience, thereby shortening the life of those components. To address such issues, a clutch is disclosed herein that allows some drivetrain components to freely rotate in one direction while engaging in the opposite direction. In some embodiments, a clutch is implemented to decrease the rotational difference between two or more drivetrain components. A control system is configured to control clutch actuators based on instructions stored in non-transitory computer readable media, for example.

In some embodiments, a clutch includes a drive plate that is coupled to a first shaft. The drive plate includes a first plurality of pawl elements and a first plurality of pockets. The clutch includes a transfer plate coupled to a second shaft, the transfer plate includes a second plurality of pockets and a second plurality of pawl elements. In certain embodiments, the first plurality of pockets are configured to receive the second plurality of pawl elements, and the second plurality pockets are configured to receive the first plurality of pawl elements.

In some embodiments, the drive plate includes an outer diameter surface. The first plurality of pawl elements are located along the outer diameter surface. The transfer plate includes a recess extending in a direction from a first face of the transfer plate to a second recessed face of the transfer plate. The recess includes an inner diameter surface, the second plurality of pockets are located along the inner diameter surface, and the first plurality of pawl elements are extendable in a radial direction and are actuatable to engage the second plurality of pockets.

In some embodiments, the first plurality of pockets are located on a face of the drive plate, and the second plurality of pawl elements are located on the second recessed face and extendable in an axial direction toward the first plurality of pockets.

In some embodiments, the clutch includes at least one first actuator operably connected to at least one pawl element of the first plurality of pawl elements and at least one second actuator operably connected to at least one pawl element of the second plurality of pawl elements. In some embodiments, actuating the at least one first actuator causes the at least one pawl element of the first plurality of pawl elements to extend and engage corresponding pockets of the second plurality of pockets.

In some embodiments, actuating the at least one second actuator causes the at least one pawl element of the second plurality of pawl elements to extend and engage corresponding pockets of the first plurality of pockets. In some embodiments, the at least one first actuator is actuated when the first shaft rotates in a first direction. In some embodiments, the at least one second actuator is actuated when the second shaft rotates in a second direction opposite the first direction. In some embodiments, the first shaft is a first half shaft, and the second shaft is a second half shaft. In such embodiments, the first half shaft and the second half shaft are output shafts of a differential.

In some embodiments, a differential is implemented. Such an example differential includes a differential housing that includes a first plurality of pawl elements and a first plurality of pockets. The differential may further include at least one spider gear rotatably attached to the differential housing. The differential may further include a first output gear coupled to a first shaft, the first output gear engaging the at least one spider gear. The differential may further include a second output gear coupled to a second shaft, the second output gear engaging that at least one spider gear. The differential may further include an output gear includes a second plurality of pockets and a second plurality of pawl elements. In some embodiments, the first plurality of pockets are configured to receive the second plurality of pawl elements, and the second plurality of pockets are configured to receive the first plurality of pawl elements.

In some embodiments, the differential housing includes an outer diameter surface. The first plurality of pawl elements are located along the outer diameter surface. The ring gear includes a recess extending in a direction from a first face of the ring gear to a second recessed face of the ring gear. The recess includes an inner diameter surface. The second plurality of pockets are located along the inner diameter surface. The first plurality of pawl elements are extendable in a radial direction and are actuatable to engage the second plurality of pockets.

In some embodiments, the first plurality of pockets are located on a face of the differential housing and the second plurality of pawl elements are located on the second recessed face and extendable in an axial direction toward the first plurality of pockets.

In some embodiments, at least one first actuator is operably connected to at least one pawl element of the first plurality of pawl elements, and at least one second actuator is operably connected to at least one pawl element of the second plurality of pawl elements.

In some embodiments, actuating the at least one first actuator causes the corresponding at least one first pawl element of the first plurality of pawl elements to extend and engage a corresponding pocket of the second plurality of pockets.

In some embodiments, actuating the at least one second actuator causes the corresponding at least one second pawl element of the second plurality of pawl elements to extend and engage a corresponding pocket of the first plurality of pockets. In some embodiments, the at least one first actuator is actuated when the first shaft rotates in a first direction. In some embodiments, the at least one second actuator is actuated when the second shaft rotates in a second opposite the first direction.

In some embodiments, the disclosed systems and methods engage a pawl element of a first plurality of pawl elements with a pocket of a second plurality of pockets, the first plurality of pawl elements are located in a drive plate, and the second plurality of pockets are located on a transfer plate. The disclosed systems and methods may additionally include engaging a pawl element of a second plurality of pawl elements with a pocket of a first plurality of pockets, the second plurality of pawl elements are located in the transfer plate, and the first plurality of pockets are located on the drive plate. In some embodiments, the first plurality of pockets are configured to receive the second plurality of pawl elements, and the second plurality pockets are configured to receive the first plurality of pawl elements.

In some embodiments, the drive plate includes an outer diameter surface, and the first plurality of pawl elements are located along the outer diameter surface. The transfer plate includes a recess extending in a direction from a first face of the transfer plate to a second recessed face of the transfer plate. The recess includes an inner diameter surface, and the second plurality of pockets are located along the inner diameter surface. The first plurality of pawl elements are extendable in a radial direction and are actuatable to engage the second plurality of pockets.

In some embodiments, at least one first actuator is operably connected to at least one pawl element of the first plurality of pawl elements. At least one second actuator is operably connected to at least one pawl element of the second plurality of pawl elements. In some embodiments, the at least one first actuator is actuated when the first shaft rotates in a first direction, and the at least one second actuator is actuated when the second shaft rotates in a second direction opposite the first direction.

In some embodiments, a clutch assembly includes a one-way clutch having a drive plate coupled to a first shaft, the drive plate includes a plurality of pawl elements. The clutch assembly further includes a transfer plate coupled to a second shaft; the transfer plate includes a plurality of pockets configured to receive the plurality of pawl elements. The clutch assembly further includes a friction clutch operable between an engaged state and a disengaged state. When in the engaged state, the friction clutch transfers rotational force between the first shaft and the second shaft, and when in the disengaged state, the friction clutch does not transfer rotational force between the first shaft and the second shaft.

In some embodiments, the drive plate includes an outer diameter surface. The plurality of pawl elements are located along the outer diameter surface. The transfer plate includes a recess extending in a direction from a first surface of the transfer plate to a second recessed face of the transfer plate. The recess includes an inner diameter surface. The plurality of pockets are located along the inner diameter surface. The first plurality of pawl elements are extendable in a radial direction and are actuatable to engage the plurality of pockets.

In some embodiments, the friction clutch is operable in a partially engaged state between the engaged state and the disengaged state. In some embodiments, the clutch may further include at least one actuator operably connected to at least one pawl element of the plurality of pawl elements. In some embodiments, actuating the at least one actuator causes the at least one pawl element of the plurality of pawl elements to extend and engage a corresponding pocket of the plurality of pockets. In some embodiments, the at least one actuator is actuated when the first shaft rotates in a first direction. In some embodiments, the friction clutch operates in the engaged state when the shaft rotates in the first direction. In some embodiments, the friction clutch operates in the engaged state when the second shaft rotates in a second opposite the first direction.

In some embodiments, a side shaft assembly is disclosed that includes a drive plate coupled to a first shaft that is connected to an output of a differential of a vehicle, the drive plate includes a plurality of pawl elements. The side shaft assembly includes a transfer plate coupled to a second shaft that is connected to a wheel output shaft of the vehicle, the transfer plate includes a plurality of pockets configured to receive the plurality of pawl elements. The side shaft assembly includes a friction clutch operable between an engaged state and a disengaged state. When in the engaged state, the friction clutch transfers rotational force between the first shaft and the second shaft, and when in the disengaged state, the friction clutch does not transfer rotational force between the first shaft and the second shaft.

In some embodiments, the drive plate includes an outer diameter surface, and the plurality of pawl elements are located along the outer diameter surface. The transfer plate includes a recess extending in a direction from a first surface of the transfer plate to a second recessed face of the transfer plate and the recess includes an inner diameter surface. The plurality of pockets are located along the inner diameter surface, and the first plurality of pawl elements are extendable in a radial direction and are actuatable to engage the plurality of pockets.

In some embodiments, the friction clutch is operable in a partially engaged state between the engaged state and the disengaged state. In some embodiments, the side shaft further includes at least one actuator operably connected to at least one pawl element of the plurality of pawl elements. In some embodiments, actuating the at least one actuator causes the at least one pawl element of the plurality of pawl elements to extend and engage a corresponding pocket of the plurality of pockets. In some embodiments, the at least one actuator is actuated when the first shaft rotates in a first direction. In some embodiments, the friction clutch operates in the engaged state when the shaft rotates in the first direction. In some embodiments, the friction clutch operates in the engaged state when the second shaft rotates in a second opposite the first direction.

In some embodiments, the disclosed systems and methods include engaging a plurality of pawl elements with a plurality of pockets, the plurality of pawl elements located in a drive plate coupled to a first shaft, the plurality of pockets located in a transfer plate coupled to a second shaft. The disclosed systems and methods may further include operating a friction clutch between an engaged state and a disengaged state. When in the engaged state, the friction clutch transfers rotational force between the first shaft and the second shaft, and when in the disengaged state, the friction clutch does not transfer rotational force between the first shaft and the second shaft.

In some embodiments, the drive plate includes an outer diameter surface, and the plurality of pawl elements are located along the outer diameter surface. The transfer plate includes a recess extending in a direction from a first surface of the transfer plate to a second recessed face of the transfer plate. The recess includes an inner diameter surface, and the plurality of pockets are located along the inner diameter surface. The first plurality of pawl elements are extendable in a radial direction and are actuatable to engage the plurality of pockets.

The disclosed systems and methods may further include detecting a rotational velocity of the first shaft, detecting a rotational velocity of the second shaft, determining a rotational velocity difference by comparing the rotational velocity of the first shaft to the rotational velocity of the second shaft, comparing the rotational velocity difference to a rotational velocity threshold, and based on determining that the rotational velocity difference is above the rotational velocity threshold, incrementally engaging the friction clutch.

The disclosed systems and methods may further include based on determining that the rotational velocity difference is above the rotational velocity threshold, adjusting a rotational velocity of a motor-generator of the vehicle.

### BRIEF DESCRIPTION OF THE DRAWINGS

The above and other objects and advantages of the disclosure will be apparent upon consideration of the following detailed description, taken in conjunction with the accompanying drawings, in which:

FIG. 1 depicts an illustrative cross-sectional diagram of a clutch, in accordance with embodiments of the disclosure;

FIG. 2 depicts an illustrative cross-sectional diagram of a differential, in accordance with embodiments of the disclosure;

FIG. 3 depicts an illustrative cross-sectional diagram of a clutch implementing a one-way clutch and a friction clutch, in accordance with embodiments of the disclosure;

FIG. 4 depicts an illustrative cross-sectional diagram of a side shaft assembly implementing a differential, a one-way clutch, and a friction clutch, in accordance with embodiments of the disclosure;

FIG. 5 depicts an illustrative process of a system for implementing a clutch, in accordance with embodiments of the disclosure;

FIG. 6 depicts a block diagram of an illustrative system for managing a clutch, in accordance with embodiments of the disclosure; and

FIG. 7 depicts an illustrative process for managing a clutch system, in accordance with embodiments of the disclosure.

### DETAILED DESCRIPTION

The present disclosure is directed to clutch assemblies configured to be capable of regeneration. For example, some clutch assemblies of the present disclosure, when engaged, allow for torque to be transferred between rotating shafts or components in either rotational direction. For example, because the torque transferred when the vehicle is accelerated in a forward direction may be greater than for movement in a reverse direction, and also greater than torque transfer during regeneration, the clutch mechanisms may be configured and arranged differently. In a further example, because different types of clutches may engage and disengage with respective characteristics (e.g., vibration, chatter, damping), mechanical clutches may be used along friction clutches to help control engagement and disengagement. For example, a clutch assembly may include two clutches, at least one of which may be a one-way clutch.

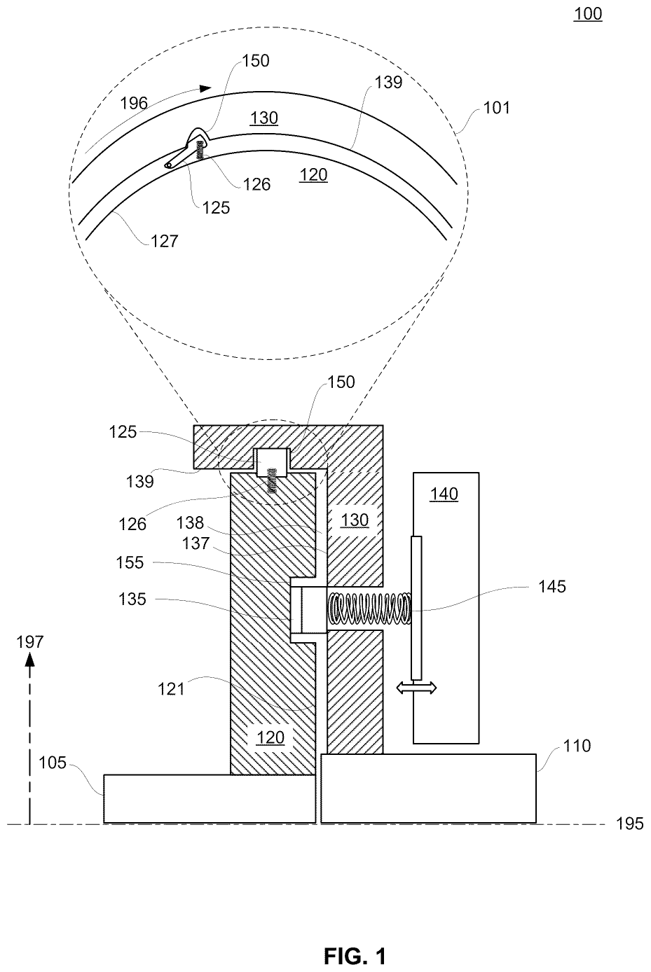

As illustrated in FIG. 1, clutch assembly 100 includes first shaft 105 and second shaft 110. Drive plate 120 is connected to first shaft 105 such that when first shaft 105 rotates, drive plate 120 also rotates. Transfer plate 130 is connected to second shaft 110 such that when second shaft 110 rotates, transfer plate 130 also rotates. Enlargement 101 illustrates an enlarged view of pawl element 125 and pocket 150.

As illustrated, drive plate 120 includes one or more pawl elements, illustrated by pawl element 125. In some embodiments, transfer plate 130 includes a plurality of pockets, illustrated by pocket 150, each configured to receive a pawl element 125. Although a single pawl element 125 may be illustrated, transfer plate 130 may include any number of pawl elements without departing from the contemplated embodiments. Transfer plate 130 includes pocket 150. In such an embodiment, pocket 150 and/or pawl element 125 may be configured such that pawl element 125 engages with pocket 150. For example, pawl element 125 engages by pivoting passively (e.g., via spring force provided by spring 126) into geometrically specialized (e.g., matching or mating) pockets 150 on transfer plate 130. Such engagement may occur, for example, when the rotational velocity of the drive plate 120 is greater than the rotational velocity of the transfer plate 130. Alternatively, pawl element 125 may be actively engaged with pocket 150 via an actuator (not shown). Although a single pocket 150 is illustrated, transfer plate 130 may include any number of pockets without departing from the contemplated embodiments. Additionally, although drive plate 120 may be illustrated and described as having a number of pawl elements matching the number of pockets included with transfer plate 130, the number of pawl elements may be different than the number of pockets, without departing from the contemplated embodiments.

As illustrated, pawl element 125 may be configured to extend radially from drive plate 120 into pocket 150 of transfer plate 130. In such embodiments, pawl element 125 engages pocket 150, thereby locking the rotational movement of drive plate 120 and transfer plate 130. In some embodiments, pawl element 125, pocket 150, or both may be configured such that pawl element 125 partially or completely disengages when the rotational speed of transfer plate 130 (e.g., in azimuthal direction 196) is greater than the rotational speed of drive plate 120.

In some embodiments, transfer plate 130 includes pawl element 135 that extends into and engages with pocket 155 of drive plate 120. In some embodiments, pawl element 135 may include spring-loaded and geometrically specialized strut elements that are arranged and/or retained in transfer plate 130. Pawl element 135 may be actuated passively, e.g., by using spring force provided by spring 145. Alternatively, pawl element 135 may be actuated actively, for example, by actuator 140. In some embodiments, pawl element 135, pocket 155, or both may be configured such that pawl element 135 partially or completely disengages when the rotational speed of transfer plate 130 is greater than the rotational speed of drive plate 120. Although actuator 140 may be illustrated and described as including spring 145, actuator may use or include any technique for actuating pawl element 135, without departing from the contemplated embodiments.

In some embodiments, pawl element 135 and/or actuator 140 may be configured such that one or more parameters are maintained. For example, clutch assembly 100 may be configured such that the rotational velocity of first shaft 105 and/or second shaft 110 is maintained or limited. In such an example embodiment, clutch assembly 100 may be configured such that the rotational velocity of second shaft 110 is limited to a predefined speed. In such embodiments, pawl element 135 and/or actuator 140 may be configured such that pawl element 135 partially or completely disengages when second shaft 110 and/or transfer plate 130 reach the predefined rotational speed. Additionally, pawl element 135 and/or actuator 140 may be configured to partially disengage by decreasing engagement as the rotational velocity increments closer to the defined maximum rotational velocity. In embodiments including a motor, such a motor may be engaged to lower the relative rotational velocity between second shaft 110 and first shaft 105 to be within a threshold.

In some embodiments, clutch assembly 100 may be configured such that the torque transferred between first shaft 105 and second shaft 110 is maintained or limited. In some such embodiments, clutch assembly 100 may be configured such that a torque experienced by second shaft 110 is limited to a predetermined torque. In such embodiments, pawl element 125, pawl element 135, actuator 140, or a combination thereof may be configured such that pawl element 135 and/or pawl element 125 partially or completely disengages when first shaft 105 and/or second shaft 110 reach the defined torque load. Additionally, pawl element 125, pawl element 135, actuator 140, or a combination thereof may be configured to partially disengage by decreasing engagement as the torque experienced by first shaft 105 and/or second shaft 110 increments closer to the defined maximum toque loading.

In some embodiments, first shaft 105 is an output shaft of a motor-generator or other suitable powertrain component of an electric vehicle (not pictured in FIG. 1). Second shaft 110 may be an output shaft or other suitable powertrain component that supplies rotational movement to a wheel of the vehicle. In some embodiments, first shaft 105 and second shaft 110 rotate about axis 195. Drive plate 120 is affixed or otherwise attached to first shaft 105 such that drive plate 120 rotates with first shaft 105. In such an embodiment, drive plate 120 has the same rotational velocity as first shaft 105. Additionally, transfer plate 130 may be attached or otherwise affixed to second shaft 110 and, in such an embodiment, transfer plate 130 rotates with the same rotational velocity as second shaft 110 as it rotates about axis 195.

In some embodiments, when first shaft 105 is subjected to rotational velocity from an electric motor-generator or drive unit (not shown), for example, pawl element 125 engages with pocket 150, fixing drive plate 120 to transfer plate 130, thereby causing transfer plate 130 and second shaft 110 to rotate at the same rotational velocity as first shaft 105 and drive plate 120. In some such embodiments, the rotational movement of the vehicle's motor-generator may be transferred to one or more of the electric vehicle's wheels (e.g., causing the vehicle to move). This configuration may be referred to as a propulsion mode/state, for example. In this way, power generated at the vehicle's motor-generator is transferred to the vehicle's wheels, causing the vehicle to move.

In some embodiments, when second shaft 110 is subjected to rotational velocity from the rotation of a vehicle's wheel (not shown), for example, pawl element 135 engages with pocket 155, fixing transfer plate 130 to drive plate 120, thereby causing drive plate 120 and first shaft 105 to rotate at the same rotational velocity as second shaft 110 and transfer plate 130. In such an embodiment, the rotational movement of one or more of the vehicle's wheels is transferred to the electric vehicle's motor-generator, thereby allowing the motor-generator to generate electric power. Such a configuration may be referred to as a regeneration mode/state. In this way, clutch assembly 100 enables the electric vehicle to use the vehicle's momentum to generate electric power.

In some embodiments, the one or more parameters considered in determining whether to engage or disengage pawl element 125, pawl element 135, or both may be dependent on other factors. For example, a defined maximum rotational velocity, maximum torque, or both experienced may be dependent on rotational direction (e.g., differing rotational maximum velocities and/or torque for different rotational directions), operational mode (e.g., a propulsion state versus a regeneration state; or when the vehicle is being operated in “sport mode” versus “economy mode”), direction of vehicle travel (e.g., forward or reverse), conditions the vehicle is experience (e.g., high/low radial/tangential acceleration (i.e., the vehicle turning or cornering)), vehicle operating conditions (e.g., dry roads versus wet roads), vehicle accelerator and/or brake positioning/application (e.g., clutch assembly 100 may operate in its regeneration state when the vehicle's accelerator pedal is not engaged and/or when the brakes are applied), any other parameter relevant to the clutch's 100 operation, or any combination thereof.

In an illustrative example, drive plate 120 may include radially outward-facing surface 127 (e.g., an outer diameter surface), and the plurality of pawl elements (e.g., including pawl element 125) are located along radially outward-facing surface 127. Transfer plate 130 may include recess 138 extending in a direction from first surface 137 to recessed face 139. For example, recess 138 may include both first surface 137 and recessed face 139 (e.g., a radially inward-facing surface or an inner diameter surface) in which the plurality of pockets are arranged. The plurality of pawl elements are extendable in radial direction 197 and are actuatable to engage the plurality of pockets.

In an illustrative example, drive plate 120 may be coupled to first shaft 105 and include a first plurality of pawl elements (e.g., including pawl element 125) and a first plurality of pockets (e.g., including pocket 155). Transfer plate 130 may be coupled to second shaft 110 and include a second plurality of pockets (e.g., including pocket 150) and a second plurality of pawl elements (including pawl element 135). For example, the first plurality of pockets are configured to receive the second plurality of pawl elements, and the second plurality pockets are configured to receive the first plurality of pawl elements. As illustrated, first plurality of pockets (e.g., including pocket 155) is arranged on face 121 of drive plate 120, which may face towards transfer plate 130. To illustrate, the first plurality of pawl elements may be arranged at a greater diameter (e.g., more radially outward from the axis of rotation), such that force loadings for a given total torque are reduced. Similarly, the second plurality of pawl elements, which may be used for lesser expected loadings (e.g., moving in reverse or regeneration) may be arranged radially inward, nearer to the axis of rotation).

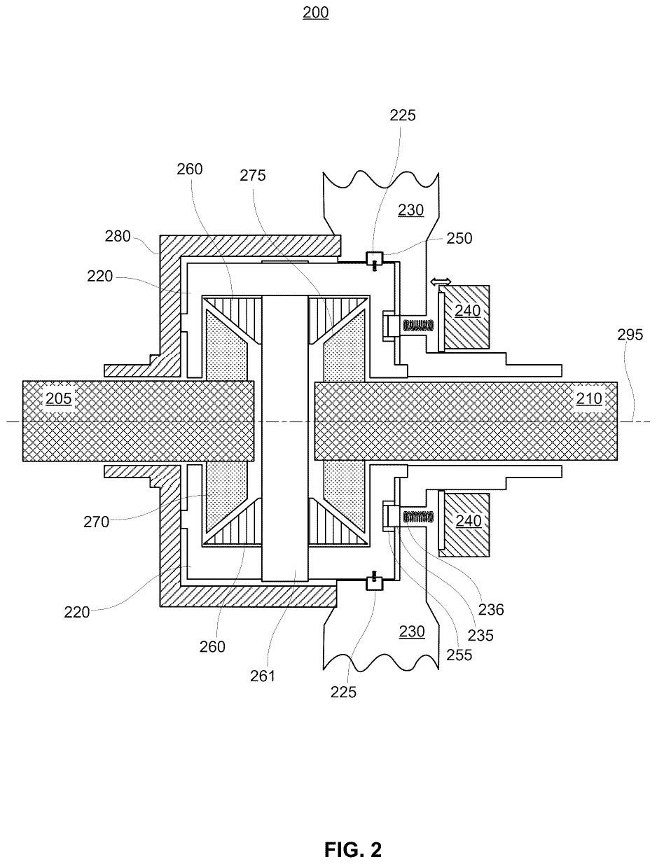

FIG. 2 shows a cross-sectional view of differential 200, in accordance with some embodiments of the present disclosure. As illustrated, differential 200 includes left half shaft 205 and right half shaft 210. Output gear 270 is attached or otherwise affixed to left half shaft 205. Similarly, output gear 275 is attached or otherwise affixed to right half shaft 210. Differential 200 further includes spider gears 260 affixed to and configured to rotate about shaft 261. In some embodiments, ring gear 230 may be connected (either directly or indirectly) to a motor or motor-generator (not pictured). Differential 200 additionally includes differential housing 220 (also referred to as a differential nest, differential case, or differential cage). Differential cover 280 encases some or all of components of differential 200. Although left half shaft 205 and right half shaft 210 may be referred to as “left” and “right,” such identifications are for illustrative purposes only and the contemplated embodiments include other configurations of half shafts independent of directional labeling.

In some embodiments, ring gear 230 includes features of a transfer plate such as, for example, transfer plate 130 as discussed with respect to FIG. 1. For example, ring gear 230 may include pawl elements 235 that each engage with a respective pocket of pockets 255. In some embodiments, pawl elements 235 may be actuated passively or actively. For example, pawl elements 235 may be passively actuated (e.g., using springs 236 or struts). Alternatively, or in addition, pawl elements 235 may be actively actuated by one or more actuators of actuator 240.

In some embodiments, differential housing 220 includes features of, or otherwise functions as, a drive plate such as, for example, drive plate 120 as discussed with respect to FIG. 1. For example, differential housing 220 may include pawl elements 225 that engage with pockets 250. In some embodiments, pawl elements 225 may be actuated passively or actively. For example, pawl elements 235 may be passively actuated using, e.g., springs or struts. Alternatively, or additionally, pawl elements 235 may be actively actuated by one or more actuators (not shown).

In some embodiments, differential 200 may be implemented in a vehicle such as an electric vehicle, for example, in transferring power from an electric motor to two or more wheels of the vehicle. In such embodiments, the electric motor-generator or drive unit is connected (either directly or indirectly) to ring gear 230 and supplies rotational power to ring gear 230 and may receive rotational movement from the wheels to generate electric power. In such example embodiments, the electric vehicle may be capable of operating in a propulsion mode or a regeneration mode.

While operating in a propulsion mode, the electric motor-generator supplies rotational power to ring gear 230. In the propulsion mode, pawl elements 225 are engaged with pockets 250, causing differential housing 220 to rotate with ring gear 230. Differential housing 220 power through spider gears 260, which then rotate output gears 270 and 275. Since output gear 270 is attached or otherwise affixed to left half shaft 205, and output gear 275 is attached or otherwise affixed to right half shaft 210, left half shaft 205 and right half shaft 210 rotate with output gears 270 and 275. Left half shaft 205 may be connected (either directly or indirectly) to, e.g., a left wheel of the vehicle and right half shaft 210 may be connected (either directly or indirectly) to, e.g., a right wheel of the vehicle. In such exemplary embodiments, power is transferred from the motor-generator of the electric vehicle and distributed between the left and right wheels (e.g., the rear wheels in a rear-wheel drive vehicle, the front wheels in a front wheel drive vehicle, or all four wheels in an all-wheel drive vehicle).

While operating in a regeneration mode, the electric motor-generator receives rotational power from the wheels of the vehicle. In the regeneration mode, left half shaft 205 may be connected (e.g., directly or indirectly) to, for example, a left wheel of the vehicle and right half shaft 210 may be connected (e.g., directly or indirectly) to, for example, a right wheel of the vehicle. Output gear 270 is attached or otherwise affixed to left half shaft 205, and output gear 275 is attached or otherwise affixed to right half shaft 210, left half shaft 205 and right half shaft 210 rotate with output gears 270, 275. Differential housing 220 is connected to spider gears 260 (e.g., by shaft 261), which then rotate output gears 270 and 275. Pawl elements 235 are engaged with pockets 255, causing spider gears 260 and differential housing 220 to rotate with output gears 270, 275. In such exemplary embodiments, rotational power is transferred from the wheels of the electric vehicle (not shown) to ring gear 230. The rotational power is then transferred to the motor-generator that is then capable of generating electric power form such rotational movement. In this way, differential 200 facilitates the vehicle's regeneration mode by transferring power from the wheels to the motor-generator.

Differential 200 varies the engagement, rotational velocity, or both of half shafts 205 and 210 relative to the rotational velocity from a motor-generator, for example. In such example embodiments and while operating in the propulsion mode, pawl elements 225 engage pockets 250. As illustrated, pawl elements 225 are located at the outer circumference of differential housing 220. Because such locations are further from the axis of rotation of differential housing 220, the forces (e.g., shear and bending forces) experienced by pawl elements 225 and pockets 250 is minimized. In some embodiments, pawl elements 225 are configured such that when the rotational velocity of differential housing 220 is greater than the rotational velocity of ring gear 230, pawl elements 225 disengage from pockets 250, allowing differential housing 220 and half shafts 205, 210 to freely rotate. In such embodiments, differential 200 ensures that the motor-generator applies rotational power to the wheels only when the input rotational velocity (e.g., the rotational velocity of ring gear 230) is greater than the rotational velocity of half shafts 205, 210.

Conversely, while operating in regeneration mode, pawl elements 235 engage pockets 255. As illustrated, pawl elements 235 are located closer to the axis of rotation 295 as compared to pawl elements 225. In some embodiments, pawl elements 235 and/or pockets 255 are configured such that when the rotational velocity of ring gear 230 is greater than the rotational velocity of differential housing 220, pawl elements 235 disengage from pockets 255. Such configurations allow ring gear 230 to freely rotate when the rotational velocity of ring gear 230 greater than the rotational velocity of differential housing 220.

In some embodiments, pawl elements 235 and/or pockets 255 may be configured such that the engagement between pawl elements 235 and pockets 255 is variable. For example, pawl elements 235 may be configured such that they can incrementally engage pockets 255 between no engagement to fully/completely engaged. Such embodiments allow pawl elements 235 to incrementally engage pockets 255 such that the rotational velocity difference between differential housing 220 and ring gear 230 may be incrementally decreased. In some embodiments, the difference in rotational velocities is decreased until the rotational velocity of ring gear 230 matches that of differential housing 220. In other embodiments, the rotational velocity difference between differential housing 220 and ring gear 230 may be incrementally decreased until an identified rotational velocity of either differential housing 220 and/or ring gear 230 is reached. Such embodiments minimize the noise, vibration, and/or harshness related to the engagement while allowing differential 200 to regulate the rotational power applied and/or the rotational velocity of various components.

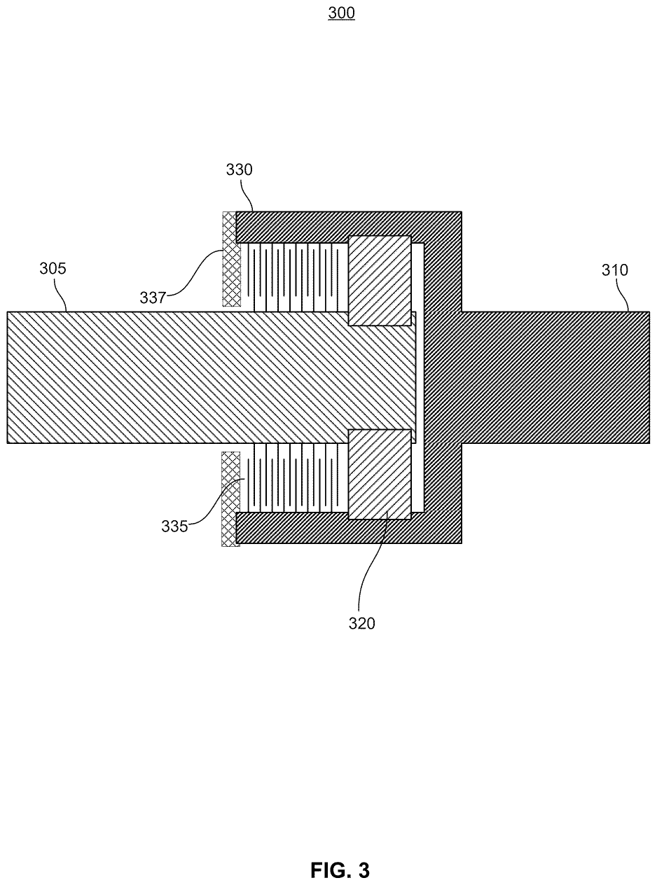

In some example embodiments of the present disclosure and with reference to FIG. 3, clutch 300 includes first shaft 305 and second shaft 310. Clutch 300 additionally includes friction clutch pack 335 and one-way clutch 320. In some embodiments, one-way clutch 320 includes pawl elements (not shown) with corresponding pockets in transfer plate 330. Example pawl elements are discussed herein such as, for example, pawl element 125 as discussed with respect to FIG. 1 and pawl element 225 as discussed with respect to FIG. 2. As illustrated, friction clutch pack 335 and one-way clutch 320 transfer rotational movement between first shaft 305 and second shaft 310. Friction clutch pack 335 may include, or otherwise be mechanically interfaced with, actuator 337. Examples of actuator 337 include a hydraulic actuator, a clutch fork, an electric linear actuator, or a rotary worm gear actuator, which may be configured to engage and disengage friction clutch pack 335, thereby engaging and disengaging first shaft 305 and transfer plate 330. In some embodiments, actuator 337 is configured to actuate friction clutch pack 335 incrementally or continuously between complete disengagement and complete engagement. In some embodiments, one-way clutch 320 can be passively engaged by, e.g., springs or struts configured to engage pawl elements of one-way clutch 320 with pockets of transfer plate 330. In other embodiments, one-way clutch 320 is actively engaged by, e.g., an actuator (not shown) configured to engage pawl elements of one-way clutch 320 with pockets of transfer plate 330.

In an example embodiment, first shaft 305 is the supplied rotational movement by, e.g., an electric motor-generator (not shown). Rotational movement is transferred to one-way clutch 320 that, in turn, transfers rotational movement to transfer plate 330. Transfer plate 330 is attached or otherwise affixed to second shaft 310, causing second shaft 310 to rotate.

In some example embodiments, second shaft 310 is rotated by, e.g., a wheel of a vehicle. Such rotation is transferred to transfer plate 330. Friction clutch pack 335 transfers the rotational movement to first shaft 305. In some embodiments, friction clutch pack 335 is incrementally engaged (e.g., using actuator 337) until the rotational velocity of first shaft 305 matches that of second shaft 310. In other embodiments, friction clutch pack 335 is incrementally engaged until the rotational velocity of first shaft 305 reaches and identified or determined. In other embodiments, friction clutch pack 335 is incrementally engaged until the torque experienced by first shaft 305 reaches and identified or determined amount. By incrementally engagement and/or disengaging friction clutch pack 335, clutch 300 minimizes the noise, vibration, and/or harshness associated with engaging first shaft 305 with second shaft 310.

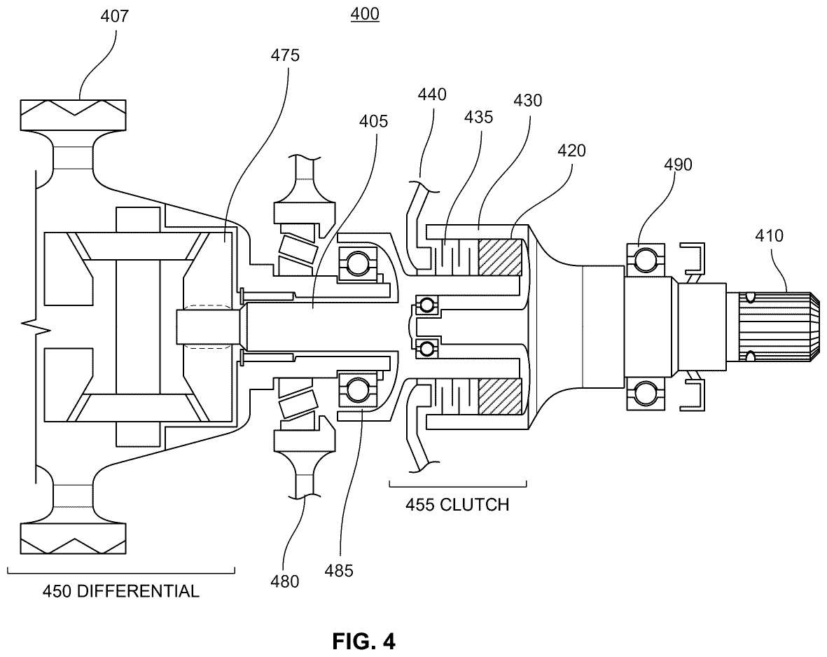

FIG. 4 depicts an illustrative cross-sectional diagram of a side shaft assembly implementing a differential, a one-way clutch, and a friction clutch, in accordance with embodiments of the disclosure. In some example embodiments of the present disclosure and with reference to FIG. 4, side shaft assembly 400 includes differential 450 and clutch 455. Example features of differential 450 are discussed herein, for example, those discussed with respect to differential 200 of FIG. 2. Example features of clutch 455 are discussed herein, for example, those discussed with respect to clutch 300 of FIG. 3. As illustrated, differential 450 includes ring gear 407 and output gear 475. Output gear 475 is connected to first shaft 405. Second shaft 410 is connected or otherwise affixed to transfer plate 430. Side shaft assembly 400 additionally includes friction clutch pack 435 and one-way clutch 420. One-way clutch 420 and friction clutch pack 435 are configured the transfer rotational movement between first shaft 405 and second shaft 410. Friction clutch pack 435 is actuated by actuator 440. Side shaft assembly 400 further includes support 480 (e.g., optionally with corresponding bearing), bearing 485, and bearing 490. Second shaft 410 may be connected to a wheel of a vehicle (not shown) either directly or indirectly. In some embodiments, ring gear 407 is connected to a motor-generator (not shown) either directly or indirectly. In some embodiments, friction clutch pack 435 implements materials with high coefficient(s) of friction. In other embodiments, friction clutch pack 435 may be configured such that an amount of slip tolerance is introduced.

In some embodiments, side shaft assembly 400 operates in various modes, for example, a propulsion mode and a regeneration mode. While in propulsion mode, side shaft assembly 400 transfers rotational power from an electric motor-generator (not shown) that is connected to and causes ring gear 407 to rotate. Side shaft assembly 400 transfers that rotational power from ring gear 407 to second shaft 410. Second shaft 410 may, in turn, be connected to a wheel of a vehicle (not shown). While in propulsion mode, ring gear 407 causes output gear 475 to rotate, thereby causing first shaft 405 to rotate. One-way clutch 420 is configured to transfer rotational power from first shaft 405 to transfer plate 430. In some embodiments, one-way clutch 420 includes pawl elements (not shown) that engage with pockets (not shown) in transfer plate 430. Example pawl elements are discussed herein, for example, first pawl element 125 as discussed with respect to FIG. 1, first pawl element 225 as discussed with respect to FIG. 2, and clutch 300 as discussed with respect to FIG. 3. Additionally, example pockets are discussed herein, for example, pocket 155 as discussed with respect to FIG. 1, first pocket 255 as discussed with respect to FIG. 2, and clutch 300 as discussed with respect to FIG. 3.

While in regeneration mode, side shaft assembly 400 transfers rotational movement from second shaft 410 to ring gear 407. In an example embodiment, second shaft 410 is connected to a wheel of a vehicle (not shown). During breaking, second shaft 410 carries rotational power from the wheel. That rotational power is transferred to transfer plate 430. Actuator 440 actuates friction clutch pack 435 so that the rotational power is transferred from transfer plate 430 to first shaft 405. First shaft 405, in turn, rotates output gear 475, which causes ring gear 407 to rotate. Because ring gear 407 is connected to motor-generator (not shown), such rotation enables the motor-generator to generate electric power. In some embodiments, friction clutch pack 435 is used only during regeneration mode or when the vehicle is moving backwards (i.e., reversing). In some embodiments, friction clutch pack 435 may be used to smooth engagement and disengagement of a one-way clutch (e.g., of one-way clutch 420).

When transitioning from propulsion mode to regeneration mode, actuator 440 may, in some embodiments, incrementally or continuously engage and disengage friction clutch pack 435 such that the difference in rotational velocities of first shaft 405 and second shaft 410 is incrementally/continuously decreased until first shaft 405 and second shaft 410 rotate at the same rate or within a threshold. Such incremental or continuous engagement and disengagement may be based on other factors, for example, the torque load experienced by first shaft 405, second shaft 410, one-way clutch 420, and/or friction clutch pack 435.

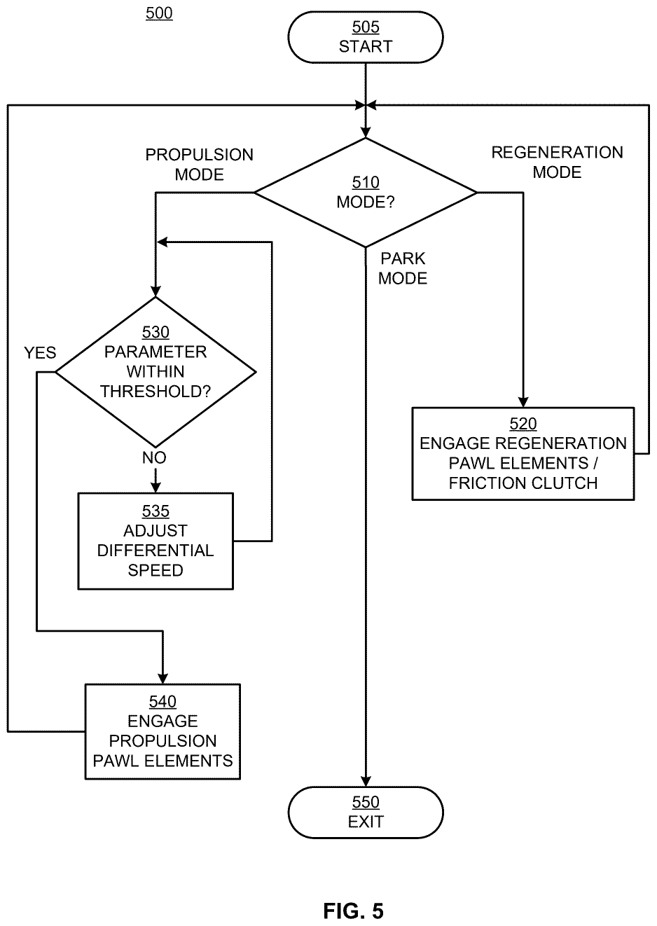

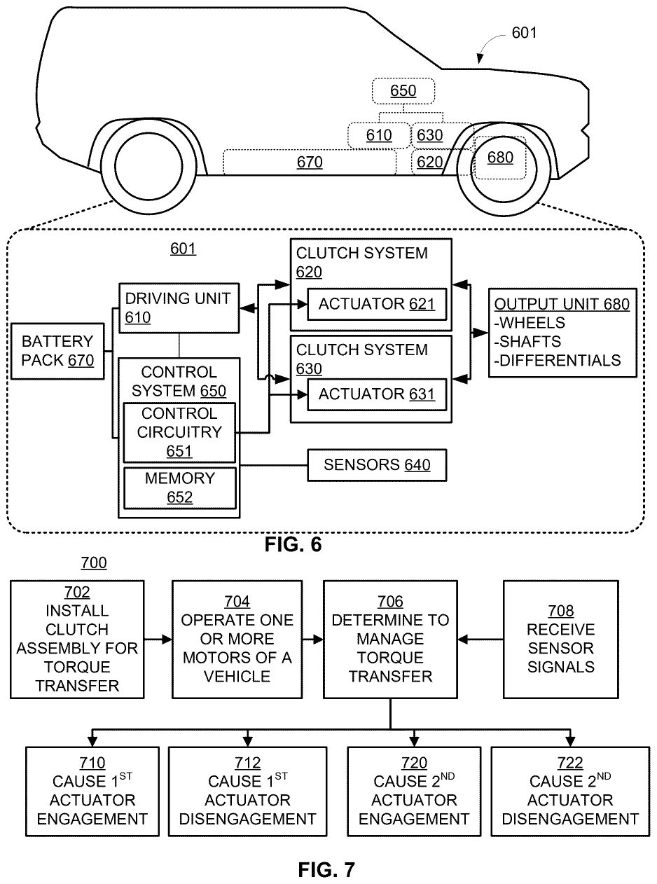

FIG. 5 depicts illustrative process 500 for implementing a clutch, in accordance with embodiments of the disclosure. For example, process 500 may be implemented by vehicle 601, or aspects thereof, of FIG. 6. In some embodiments, process 500 illustrates an example process for engaging a clutch. In some embodiments, process 500 is undertaken with respect to a clutch as a component of an electric vehicle.

At step 505, process 500 begins. Process 500 may begin when the vehicle is initiated (e.g., turned on). In some embodiments, process 500 begins based on an input such as, for example, a user selecting a selectable element (e.g., a button or switch) within the vehicle. In some embodiments, process 500 begins based on suitable factors such as, for example, road and/or driving conditions, charge level of the vehicle, or any other factor applicable to the operation of a vehicle.

At step 510, process 500 determines whether to engage propulsion mode, regeneration mode, or park mode. The determination of step 510 may be based on one or more factors. For example, at step 510, the system may determine which mode to operate in based on user input. In such an example, a user (e.g., a driver) depressing an accelerator of the vehicle causes the system to operate in propulsion mode. In some examples, the system operates in regeneration mode based on a user of the vehicle (e.g., the driver) releasing the accelerator and/or depressing the brake pedal of the vehicle. In other embodiments, the system determines the operation mode at step 510 based on one or more vehicle parameters. For example, the system may determine the operational mode based on wheel speed, vehicle speed, motor speed, lateral or longitudinal acceleration/deceleration of the vehicle (as determined by various sensors including wheel speed sensors, accelerometers, or GPS sensors), or any combination thereof. At step 510, the system may determine whether to engage park mode based on, for example, a user selecting a park selector. In the event the system determines to operate in propulsion mode, process 500 proceeds to step 530. In the event the system determines to operate in regeneration mode, process 500 proceeds to step 520. In the event the system determines to operate in park mode, process 500 proceeds to step 550, where the system exits process 500.

At step 520, process 500 engages regeneration pawl elements or a friction clutch. In embodiments, implementing regeneration pawl elements includes the system engaging one or more actuators to incrementally or continuously engage regeneration pawl elements. Example regeneration pawl elements are discussed herein such as, for example, second pawl element 135 as discussed with respect to FIG. 1 and second pawl element 235 as discussed with respect to FIG. 2. In embodiments implementing a friction clutch, the system may engage one or more actuators to incrementally or continuously actuate the friction clutch. Example friction clutches are discussed herein, for example, friction clutch pack 335 as discussed with respect to FIG. 3 and friction clutch pack 435 as discussed with respect to FIG. 4.

At step 530, the system determines whether one or more parameters are within threshold(s). For example, the system may consider the relative rotational velocity of the wheel as compared to the motor-generator. In some embodiments, the system may consider the relative rotational velocities of a first shaft (e.g., first shaft 105 as discussed with respect to FIG. 1, left half shaft 205 as discussed with respect to FIG. 2, first shaft 305 as discussed with respect to FIG. 3, and/or first shaft 405 as discussed with respect to FIG. 4) and a second shaft (e.g., second shaft 110 as discussed with respect to FIG. 1, right half shaft 210 as discussed with respect to FIG. 2, second shaft 310 as discussed with respect to FIG. 3, and/or second shaft 410 as discussed with respect to FIG. 4). In some embodiments, the system may consider the amount of torque experienced by one or more components of the drivetrain of the vehicle. Example parameters are discussed herein, for example, with respect to FIGS. 1-4. In the event that the system determines the relevant parameter is within threshold, the system proceeds to step 540. In the event that the system determines the parameter is not within a threshold, the system proceeds to step 535. Process 500 may optionally adjust the threshold, for example, based on user input or automatically.

At step 535, the system adjusts the differential speed of, e.g., the first shaft and second shaft. In some embodiments, the system adjusts one or more actuators that alter the engagement/disengagement of a propulsion pawl elements or a friction clutch. Example actuators are discussed herein, for example, actuator 140 as discussed with respect to FIG. 1, actuator 240 as discussed with respect to FIG. 2, and actuator 425 as discussed with respect to FIG. 4. In other embodiments, the system adjusts the rotational speed of a motor-generator to lower the difference in rotational velocities to within the threshold. At the conclusion of step 535, the system returns to step 530 where the system determines whether the relative rotational velocity is within threshold.

At 540, the system engages pawl elements. Engaging the pawl elements of the clutch enables the clutch to transfer rotational power from the motor-generator to the wheels of the vehicle. Features of the propulsion pawl elements and example techniques for engaging pawl element are discussed herein, for example with respect to pawl element 125 as discussed with respect to FIG. 1, pawl elements 225 as discussed with respect to FIG. 2, one-way clutch as discussed with respect to FIG. 3, and one-way clutch as discussed with respect to FIG. 4. At the conclusion of step 540, the system returns to step 510, where the system determines whether to operate in propulsion mode, regeneration mode, or park mode. Optionally, at the conclusion of step 540, the system proceeds to step 550 where the system exits process 500.

FIG. 6 depicts a block diagram of an illustrative vehicle system for managing a clutch, in accordance with embodiments of the disclosure. FIG. 6 shows a block diagram of illustrative vehicle 601 having controls system 650 for controlling one or more driving units 610, clutch system 620, and clutch system 630, in accordance with some embodiments of the present disclosure. Vehicle 601 includes battery pack 670, which is configured to provide power to driving unit 610, control system 650, actuators 621 and 631, and any other suitable corresponding equipment. Vehicle 601 includes clutch system 620 and clutch system 630, each configured to couple driving unit 610 and output unit 680 to transfer torque (e.g., in one or both directions). In a further example, clutch systems 620 and 630 may include any of the illustrative components and arrangements of FIGS. 1-4.

In some embodiments, control system 650 may include processing equipment (e.g., control circuitry 651), memory 652, power management components, and any other suitable components for controlling one or more driving units 610, clutch system 620, clutch system 630, battery pack 670, or a combination thereof. For example, control circuitry 651 may control current flow (e.g., amount of current and current direction) to phases of a motor of one or more driving units 610 (e.g., using electric power as stored in battery pack 670). In some embodiments, driving unit 610 may include an electric motor, a gearbox, a differential (e.g., where an electric motor may drive both wheels of a drive axis, as illustrated in FIG. 4), a driveshaft, a clutch (e.g., separate from clutch systems 620 and 630), or any combination thereof. In a further example, control circuitry 651 may control clutch operation (e.g., using an electromagnetically-actuated clutch) for one or more of clutch systems 620 and 630. In a further example, control circuitry 651 may control differential operation (e.g., using an electromagnetically-actuated differential) in a dual drive unit. In some embodiments, control circuitry 651 is configured to actuate and de-actuate one or more of actuators 621 and 631 (e.g., a first and second clutch actuator), a differential actuator (e.g., of output unit 680), or a combination thereof. For example, control circuitry 651 may provide control signals (e.g., communications, electric power, or both) to (i) one or more of actuators 621 and 631. In a further example, the control signals may be binary (e.g., on/off application of a DC voltage), analog (e.g., the control signal may be proportional based on a voltage range, pulse-width modulation, or pulse-density modulation), oscillatory (e.g., and AC signal or other oscillating signal), any other suitable waveform or shape (e.g., square wave, sawtooth wave, triangular wave, rectified sinusoidal wave), or any combination thereof. In some embodiments, either or both of actuators 621 and 631 are spring-loaded or otherwise biased in an engaged or disengaged state, and application of electrical power, hydraulic power, or pneumatic power may cause a change in state (e.g., engaged to disengaged, or disengaged to engaged).

In some embodiments, control circuitry 651 may include one or more sensors of sensors 640, one or more sensor interfaces (e.g., for sensors that are included as part of one or more driving units 610 or clutch systems 620 or 630), corresponding wiring, corresponding signal conditioning components, any other suitable components for sensing a state of a drive unit, or any combination thereof. For example, a position sensor (e.g., such as encoder or other suitable sensor) may be included to sense a position (e.g., an axial position such as an engaged or disengaged position) of one or more shifting components (e.g., a pin, thrust plate, or other suitable component). In a further example, control circuitry 651 may include a speed sensor (e.g., a rotary encoder), a current sensor, a voltage sensor, a temperature sensor, any other suitable sensor, or any combination thereof. In some embodiments, control circuitry 651 may be implemented by a central controller, a plurality of distributed control systems, an embedded system, or any combination thereof. For example, control circuitry 651 may be at least partially implemented by an electronic control unit (ECU). In a further example, vehicle 601 may include a power electronics system that is controlled by the ECU and is configured to manage current to one or more motors, one or more engines, or a combination thereof, of one or more driving units 610.

Output unit 680 may include a second member or component that may be engaged with driving unit 610 using clutch system 620 or 630. For example, either or both of clutch systems 620 and 630 may be configured to transfer torque to one or more wheels, shafts, differentials, or any other suitable rotating component, of output unit 680.

For example, some embodiments of the present disclosure use or include control system 650 to implement some or all of the features discussed herein. As illustrated, control system 650 includes control circuitry 651 that is coupled to sensors 640, actuators 621 and 631, motors (e.g., of driving unit 610), interfaces, and any other suitable components to control one or more vehicle systems or subsystems. In some embodiments, control circuitry 651 monitors sensor signals (e.g., from sensors 640), generates control signals, executes computer readable instructions (e.g., stored in memory 652), receives inputs, or a combination thereof. In some embodiments, control circuitry 651 provides power and/or a data connection to the one or more vehicle systems or subsystems.

In some embodiments, control system 650 includes communications circuitry for communicating with other systems. In some embodiments, the communications circuitry includes any of an antenna, receiver, transceiver, transceiver circuitry, or other circuitry, or any combination thereof, and may be configured to access the internet, a local area network, wide area network, Bluetooth-enabled device, near field communication (NFC)-enabled device, Wi-Fi enabled device, cellular (e.g., 2G/3G/4G/5G) enabled device, or any other suitable device using any suitable protocol. In some embodiments, the communications circuitry is used to communicate with an accessory or another system (e.g., another vehicle, server, or user device (e.g., smartphone)). In some embodiments, the control circuitry receives an input from a user device that is not connected to a cellular network. In some embodiments, control system 650 includes input/output (I/O) circuitry (e.g., or I/O path) to receive inputs and/or send outputs. In some embodiments, the I/O circuitry receives inputs from and/or sends outputs to at least one of an actuator, user interface, sensors, or communications circuitry. In some embodiments, the control circuitry communicates with a device through the I/O circuitry. In some embodiments, the I/O circuitry includes, or replaces, the communications circuitry. In some embodiments, vehicle 601 may communicate with and enable a control of one or more vehicle systems.

In some embodiments, control system 650 includes storage such as an electronic storage device provided as part of, or communicatively coupled to, control circuitry 651. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. The storage may be used to store various types of content described herein as well as sensor data as described below. In some embodiments, nonvolatile memory is also used (e.g., to launch a boot-up routine and other instructions). In some embodiments, cloud-based storage or server-based storage is used to supplement storage or instead of the storage. In some embodiments, the storage includes non-transitory memory with non-transitory instructions, that when executed, cause the execution of applications to control aspects of the accessories and/or performance characteristics of the vehicle. For example, as illustrated, control system 650 includes memory 652, which include non-transitory media for storing computer instructions. In one example, the control circuitry and I/O circuitry are part of the computer having the non-transitory memory. In some embodiments, the instructions are provided by the control circuitry through the I/O circuitry and/or communications circuitry.

In some embodiments, vehicle 601 includes a power delivery system such as, for example, a system having controllable electrical contacts for providing power. In some embodiments, the electrical source includes battery pack 670 (e.g., also referred to as an energy storage system (ESS)) that may include a plurality of battery cells, enclosures, and power electronics (e.g., a DC-DC converter, switches, alternator). Battery pack 670 may be configured to provide power to driving unit 610, which may include motors, gearing, bearings, hubs, shafts, gearbox housings, any other suitable components, or any combination thereof. For example, each drive unit may include an inverter, electric motor, and a gearbox for providing torque to a respective wheel or drive axis of the electric vehicle via a half-shaft and constant-velocity (CV) joint.

To illustrate, vehicle 601 includes a propulsion system (e.g., a drive machine that may include one or more driving units 610) to drive movement of the vehicle. In some embodiments, the propulsion system includes one or more electric motors to rotate wheels of the vehicle. In some embodiments, the electric motors are couped to a driveshaft that is coupled to the wheels. In some embodiments, the electric motors directly drive rotation of the wheels. In some embodiments, the propulsion system includes a combustion engine (e.g., using gas, diesel, or a fuel cell) to rotate wheels of the vehicle. In some embodiments, the propulsion system generates torque to rotate the wheels. One or more sets of clutch systems 620 and 630 may be included (e.g., a set for each drive motor, wheel, or drive axle) to transfer power between the propulsion system and output.

Sensors 640 may generate different types of data that may be stored in memory 652. In some embodiments, sensors 640 sense characteristics of an environment surrounding vehicle 601 or information about the environment. In some embodiments, sensors 640 sense characteristics of vehicle 601 or information about a status or state. In some embodiments, sensors 640 sense any of a speed, velocity, acceleration, position, angle, orientation, displacement, vibration, temperature, or weight of the vehicle or vehicle part, component, or subsystem. In some embodiments, sensors 640 sense a gear position (e.g., park, reverse, drive) or emergency/parking brake status (e.g., engaged or disengaged). In some embodiments, control circuitry 651 adjusts a vehicle parameter associated with characteristics to adjust the vehicle performance or the vehicle's status or state. In some embodiments, sensors 640 are configured to sense characteristics about a translational system of the vehicle. In some embodiments, the translational characteristics include any of the accelerator and/or brake pedal position, steering wheel position, wheel position, wheel rotation direction, wheel torque, propulsion system output (e.g., engine torque), or estimated range of vehicle 601. In some embodiments, control circuitry 651 adjusts a vehicle parameter associated with the translational characteristics. In some embodiments, the translational vehicle parameter includes any of steering, braking, or acceleration sensitivity or responsiveness. In some embodiments, the translational vehicle parameter includes any of a threshold or limits for the steering, braking, or acceleration. In some embodiments, the translational vehicle parameter includes any of a threshold or limits for the vehicle range or a vehicle state of charge. In some embodiments, the translational vehicle parameter includes a gear position or emergency/parking brake status. In some embodiments, sensors 640 are configured to sense characteristics about a suspension of the vehicle such as any of firmness or height. In some embodiments, control circuitry 651 adjusts a vehicle parameter associated with the suspension characteristics. In some embodiments, the suspension vehicle parameter includes any of spring stiffness, damping coefficients, tire stiffness, or ride height (e.g., height off the ground or a center of gravity height). In some embodiments, control circuitry 651 changes a suspension vehicle parameter by adjusting any of a damping coefficient or ride height of the suspension system.

In some embodiments, sensors 640 are configured to sense characteristics about an electrical system of vehicle 601. In some embodiments, the electrical characteristics include any of current, voltage, resistance, or temperature. In some embodiments, the electrical system includes the propulsion system. In some examples, the electrical characteristics include current state of charge, battery capacity, or charging rates of a battery. In some embodiments, control circuitry 651 adjusts a vehicle parameter associated with the electrical characteristics. In some embodiments, the electrical vehicle parameter includes any of current, voltage, or resistance. In some embodiments, the electrical vehicle parameter includes any of a threshold or limits for the voltage or current. In some embodiments, the electrical vehicle parameter includes any of a threshold or limits for the charging rates.

In some embodiments, sensors 640 include any of a current sensor, voltage sensor, temperature sensor, an odometer, an encoder, a global positioning system (GPS) receiver, position sensor, current sensor, voltage sensor, temperature sensor, proximity sensor (e.g., radar sensor, laser radar sensor, ultrasonic sensor, lidar sensor, infrared sensor, light sensor, Hall sensor), pressure sensor, pressure sensor, load sensor, accelerometer, gyrometer (or gyro sensor), inertial measurement unit, tags and readers (e.g., radio frequency identification (RFID), NFC beacon, or Bluetooth beacon) or a camera.

In some embodiments, control circuitry 651 uses one or more of sensors 640 to detect whether an accessory is attached and/or aspects or properties of the accessory. In some embodiments, a proximity sensor or camera is used to detect the presence of an accessory. In some embodiments, control circuitry 651 accesses a database of vehicle and accessory characteristics (e.g., via I/O circuitry) to detect whether an accessory is attached. In some embodiments, the database includes entries for different accessory types. In some embodiments, the entries indicate any of conditions (e.g., sensor values) for the identifying accessory type, aspects or properties on the accessory type, and controllable elements for the accessory type. In some embodiments, control circuitry 651 compares sensor data to data in the database to identify the presence of the accessory. In some embodiments, control circuitry 651 accesses the database to determine aspects or properties of the accessory. In some examples, the aspects include dimensions, weight, and other properties of the accessory. In some examples, the aspects include the presence of controllable elements that can be controlled by control circuitry 651, such as described herein.

In an illustrative example, control circuitry 651 may be configured to adjust a translational vehicle parameter by adjusting a limit for acceleration (e.g., and deceleration) and setting maximum speed to account for the weight of the accessory and the drag imparted by the accessory. In some embodiments, control circuitry 651 changes a translational vehicle parameter by setting or confirming a gear position (e.g., change to or stay in park) or an emergency/parking brake status (e.g., engage) to allow use of the accessory (e.g., a camper shell). In some embodiments, control circuitry 651 changes a translational vehicle parameter by adjusting the vehicle range to account for the reduction on range imparted by the accessory.

In an illustrative example, a drive system may include a first drive unit and optionally a second drive unit (e.g., two instances of driving unit 610), each including one or more clutch assemblies (e.g., clutch system 620, clutch system 630, or both), and a differential assembly (e.g., of output unit 680). In some embodiments, a system, in addition to including a drive unit (e.g., single or dual), may include processing equipment configured to activate and deactivate one or more clutch assemblies to transfer torque, manage motor operation, manage regeneration (e.g., using the motor as a generator), perform any other control function, or any combination thereof. Activating and deactivating a clutch assembly may refer to completely, or partially, increasing or decreasing the engagement of elements of the clutch assembly (e.g., using control signals generated by control circuitry 651). For example, activating a clutch assembly may include engaging clutch elements of either or both of clutch systems 620 and 630, and transferring an amount of torque between the input and output shafts. For example, a sensor of sensors 640 may detect shaft speed (e.g., an output shaft speed, as measured by an encoder) or output torque (e.g., an output shaft torque, or a motor torque). In some embodiments, vehicle 601 may include an accelerator pedal configured to indicate a desired speed (e.g., by being depressed by a user), and control circuitry 651 may receive a signal from the accelerator pedal, determine a speed parameter based on the signal, and activate one or more clutch assemblies (e.g., clutch systems 620 and 630), one or more motors, or a combination thereof, if the speed parameter is above a threshold. For example, if a user “floors” the accelerator pedal (e.g., more than 50% demand), control circuitry 651 may activate the clutch assemblies and differential assembly to lock the output shafts of a drive axis together. In some embodiments, control circuitry 651 may activate and deactivate a clutch based on road conditions (e.g., icy roads, puddles, high winds), a drive mode (e.g., an off-road mode, a sport mode, or a traction mode), any other suitable criterion, or any combination thereof.

In an illustrative example, driving unit 610 may correspond to drive plate 120 of FIG. 1, output unit 680 may correspond to transfer plate 330, clutch system 620 may correspond to one-way clutch 320, and clutch system 630 may correspond to friction clutch pack 335 of FIG. 3. In a further illustrative example, driving unit 610 may correspond to differential 450, output unit 680 may correspond to transfer plate 430 and second shaft 410, clutch system 620 may correspond to one-way clutch 420, and clutch system 630 may correspond to friction clutch pack 435 of FIG. 4.

FIG. 7 is a flowchart of illustrative process 700 for managing a clutch system, in accordance with some embodiments of the present disclosure. In some embodiments, process 700 may overlap with, or otherwise include process 500 of FIG. 5.

Step 702 includes installing a clutch assembly configured to achieve torque transfer. Step 1802 may include installing a first clutch assembly and a second clutch assembly between a wheel and a motor, a wheel and a driveshaft, a driveshaft and a differential, a wheel and a differential, two shafts, or between any other suitable interface between rotating components, for example. The first clutch assembly may include a one-way clutch configured for propulsion mode or regeneration mode. The second clutch may include a one-way clutch configured for regeneration mode or propulsion mode, or friction clutch with controllable engagement characteristics, for example.

Step 704 includes operating one or more motors of a vehicle. For example, a vehicle may include one motor, two motors, four motors, or any other suitable number of motors, and corresponding motor controllers (e.g., having DC-AC converters) configured to control power transfer and torque transfer.

Step 706 includes determining to manage torque transfer. For example, control system 650 or control circuitry 651 thereof may determine that power or torque is to be transferred between two rotating components (e.g., a first shaft and a second shaft), and that one or more clutches are to be engaged or disengaged to manage the transfer (e.g., allow or disallow the transfer). In a further example, control system 650 may determine that torque is to be supplemented by another motor, torque is to be applied to an otherwise freewheeling shaft, or otherwise that torque is to be transferred between two rotating components. Step 706 may be performed based on input from user, a determination by control circuitry 651, or a combination thereof.

Step 708 includes receiving one or more sensor signals. For example, step 708 may include receiving a sensor signal from one or more sensors configured to detect a rotational velocity of a respective shaft. In a further example, the sensor signal may correspond to a current, a power, a force, a torque, a velocity, any other suitable parameter, any difference of change thereof, or any combination thereof.

Steps 710 and 712 include causing a first actuator of a first clutch to engage or disengage to manage torque transfer. For example, at step 710, the first actuator may apply an axial force to a clutch element (e.g., a thrust plate) to cause the clutch element to move axially. The first actuator may be configured to apply sufficient force to overcome a spring force, overcome a friction force, achieve a desired displacement dynamic (e.g., speed, acceleration, or profile thereof), any other suitable performance, or any combination thereof. Step 712 may include causing the first clutch assembly to disengage by de-activating the first actuator, for example. In some embodiments, a return spring may be configured to return the clutch element to a disengaged position, when the first actuator is not actuated. For example, when the system determines that torque is no longer to be transferred, control system 650 may disengage the clutch by de-activating the first actuator.

Steps 720 and 722 include causing a second actuator of a second clutch to engage or disengage to manage torque transfer. For example, at step 720, the second actuator may apply a force to a clutch element (e.g., a thrust plate) to cause the clutch element to move. The second actuator may be configured to apply sufficient force to overcome a spring force, overcome a friction force, achieve a desired displacement dynamic (e.g., speed, acceleration, or profile thereof), any other suitable performance, or any combination thereof. Step 722 may include causing the second clutch assembly to disengage by de-activating the first actuator, for example. In some embodiments, a return spring may be configured to return the clutch element to a disengaged position, when the second actuator is not actuated. For example, when the system determines that torque is no longer to be transferred, control system 650 may disengage the second clutch by de-activating the second actuator.

In an illustrative example, step 710 may include engaging a plurality of pawl elements (e.g., of a first clutch element) with a plurality of pockets (e.g., of a second clutch element). For example, the plurality of pawl elements (e.g., such as pawl element 125) may be located in a drive plate (e.g., drive plate 120) coupled to a first shaft (e.g., first shaft 105, and the plurality of pockets (e.g., plurality of pockets 150) located in a transfer plate (e.g., transfer plate 130) coupled to a second shaft (e.g., second shaft 110). Further steps 720 and 722 may include operating a friction clutch (e.g., friction clutch pack 335 or friction clutch pack 435) between an engaged state and a disengaged state. For example, when in the engaged state, the friction clutch transfers rotational force between the first shaft and the second shaft (e.g., at step 720). In a further example, when in the disengaged state, the friction clutch need not transfer rotational force between the first shaft and the second shaft (e.g., at step 722).

In a further illustrative example, two sensors of sensors 640 may be configured to detect a rotational velocity of the first shaft and a rotational velocity of the second shaft, and respective sensor signals may be transmitted to control system 650 (e.g., which may receive the signals at step 708). At step 706, control system 650 may determine a rotational velocity difference by comparing the rotational velocity of the first shaft to the rotational velocity of the second shaft, and then compare the rotational velocity difference to a rotational velocity threshold. For example, based on determining that the rotational velocity difference is above the rotational velocity threshold, control system 650 may incrementally engaging a friction clutch (e.g., clutch system 630). In some embodiments, at step 706, control system 650 may, based on determining that the rotational velocity difference is above the rotational velocity threshold, adjust a rotational velocity of a motor-generator of the vehicle (e.g., driving unit 610 of vehicle 601).

The processes discussed herein are intended to be illustrative and not limiting. For instance, the steps of the processes discussed herein may be omitted, modified, combined, and/or rearranged, and any additional steps may be performed without departing from the scope of the invention. More generally, the above disclosure is meant to be illustrative and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

What is claimed is:

1. A clutch comprising:
a drive plate configured to be coupled to a first shaft, the drive plate comprising a first plurality of pawl elements and a first plurality of pockets; and
a transfer plate configured to be coupled to a second shaft, the transfer plate comprising a second plurality of pockets and a second plurality of pawl elements, wherein:
the first plurality of pockets are configured to receive the second plurality of pawl elements; and
the second plurality pockets are configured to receive the first plurality of pawl elements.

2. The clutch of claim 1, wherein:
the drive plate comprises an outer diameter surface;
the first plurality of pawl elements are located along the outer diameter surface;
the transfer plate comprises a recess extending in a direction from a first face of the transfer plate to a second recessed face of the transfer plate;
the recess comprises an inner diameter surface;
the second plurality of pockets are located along the inner diameter surface; and
the first plurality of pawl elements are extendable in a radial direction and are actuatable to engage the second plurality of pockets.

3. The clutch of claim 2, wherein:
the first plurality of pockets are located on a face of the drive plate; and
the second plurality of pawl elements are located on the second recessed face and extendable in an axial direction toward the first plurality of pockets.

4. The clutch of claim 1, further comprising:
at least one first actuator operably connected to at least one pawl element of the first plurality of pawl elements; and
at least one second actuator operably connected to at least one pawl element of the second plurality of pawl elements.

5. The clutch of claim 4, wherein the at least one first actuator is actuatable to cause the at least one pawl element of the first plurality of pawl elements to extend and engage corresponding pockets of the second plurality of pockets.

6. The clutch of claim 4, wherein the at least one second actuator is actuatable to cause the at least one pawl element of the second plurality of pawl elements to extend and engage corresponding pockets of the first plurality of pockets.

7. The clutch of claim 5, wherein actuating the at least one first actuator causes transfer of rotational force from the drive plate to the transfer plate.

8. The clutch of claim 6, wherein actuating the at least one second actuator causes transfer of rotational force from the transfer plate to the drive plate.

9. The clutch of claim 1, wherein:
the first shaft is a first half shaft; and
the second shaft is a second half shaft, wherein the first half shaft and the second half shaft are output shafts of a differential.

10. A differential comprising:
a differential housing comprising a first plurality of pawl elements and a first plurality of pockets;
at least one spider gear rotatably attached to the differential housing;
a first output gear configured to be coupled to a first shaft, the first output gear engaging the at least one spider gear;
a second output gear configured to be coupled to a second shaft, the second output gear engaging the at least one spider gear; and
a ring gear comprising a second plurality of pockets and a second plurality of pawl elements, wherein:
the first plurality of pockets are configured to receive the second plurality of pawl elements; and
the second plurality of pockets are configured to receive the first plurality of pawl elements.

11. The differential of claim 10, wherein:
the differential housing comprises an outer diameter surface;
the first plurality of pawl elements are located along the outer diameter surface;
the ring gear comprises a recess extending in a direction from a first face of the ring gear to a second recessed face of the ring gear;
the recess comprises an inner diameter surface;
the second plurality of pockets are located along the inner diameter surface; and
the first plurality of pawl elements are extendable in a radial direction and are actuatable to engage the second plurality of pockets.

12. The differential of claim 11, wherein:
the first plurality of pockets are located on a face of the differential housing; and
the second plurality of pawl elements are located on the second recessed face and extendable in an axial direction toward the first plurality of pockets.

13. The differential of claim 10, further comprising:
at least one first actuator operably connected to at least one pawl element of the first plurality of pawl elements; and
at least one second actuator operably connected to at least one pawl element of the second plurality of pawl elements.

14. The differential of claim 13, wherein the at least one first actuator is actuatable to cause at least one first pawl element of the first plurality of pawl elements to extend and engage a corresponding pocket of the second plurality of pockets.

15. The differential of claim 13, wherein the at least one second actuator is actuatable to cause at least one second pawl element of the second plurality of pawl elements to extend and engage a corresponding pocket of the first plurality of pockets.

16. The differential of claim 14, wherein actuating the at least one first actuator causes transfer of rotational force from the differential housing to the ring gear.

17. The differential of claim 15, wherein actuating the at least one second actuator causes transfer of rotational force from the ring gear to the differential housing.

18. A method comprising:
engaging a pawl element of a first plurality of pawl elements with a pocket of a second plurality of pockets, the first plurality of pawl elements located in a drive plate, and the second plurality of pockets located on a transfer plate; and
engaging a pawl element of a second plurality of pawl elements with a pocket of a first plurality of pockets, the second plurality of pawl elements located in the transfer plate, and the first plurality of pockets located on the drive plate, wherein:
the first plurality of pockets are configured to receive the second plurality of pawl elements; and
the second plurality pockets are configured to receive the first plurality of pawl elements.

19. The method of claim 18, wherein:
the drive plate comprises an outer diameter surface;
the first plurality of pawl elements are located along the outer diameter surface;
the transfer plate comprises a recess extending in a direction from a first face of the transfer plate to a second recessed face of the transfer plate;
the recess comprises an inner diameter surface;
the second plurality of pockets are located along the inner diameter surface; and
the first plurality of pawl elements are extendable in a radial direction and are actuatable to engage the second plurality of pockets.

20. The method of claim 18, wherein:
at least one first actuator is operably connected to at least one pawl element of the first plurality of pawl elements;
at least one second actuator is operably connected to at least one pawl element of the second plurality of pawl elements;
the at least one first actuator is actuatable to cause transfer of rotational force from the drive plate to the transfer plate; and
the at least one second actuator is actuatable to cause transfer of rotational force from the transfer plate to the drive plate.
